(19) United States
(12) Patent Application Publication
(10) Pub. No.: US 2025/0235975 A1
(43) Pub. Date: Jul. 24, 2025

(54) SYSTEMS AND METHODS FOR LOW TEMPERATURE SANDING AND POLISHING

(71) Applicant: Lockheed Martin Corporation, Bethesda, MD (US)

(72) Inventor: Kevin Aaron Coffey, Grapevine, TX (US)

(73) Assignee: Lockheed Martin Corporation, Bethesda, MD (US)

(21) Appl. No.: 19/174,554

(22) Filed: Apr. 9, 2025

Related U.S. Application Data
(63) Continuation-in-part of application No. 18/479,549, filed on Oct. 2, 2023.

(51) Int. Cl. B24B 7/24; B24B 23/02; B64F 5/40

(52) U.S. Cl. CPC B24B 7/24; B24B 23/02; B64F 5/40

(57) ABSTRACT

A method for removing a defect from a surface includes performing a first sanding procedure using an apparatus and a first sanding pad. The apparatus cools the surface during sanding and polishing operations. The method further includes performing a second sanding procedure if the defect is removed by the first sanding procedure. The second sanding procedure utilizes a second sanding pad that has a higher grit value than the first sanding pad. The method further includes performing a first polishing procedure in order to remove sanding marks from a previous sanding procedure. The first polishing procedure utilizes a first polishing pad and a first polishing paste. The method further includes performing a second polishing procedure if the first polishing procedure removes sanding marks from the previous sanding procedure. The second polishing procedure utilizes a second polishing paste that has a lower micron value than the first polishing paste.

### CROSS-REFERENCE TO RELATED APPLICATIONS

The present application is a continuation-in-part of U.S. patent application Ser. No. 18/479,549, filed Oct. 2, 2023, and entitled “Cooling Orbital Lapping Device,” the entirety of which is herein incorporated by reference for all purposes.

### TECHNICAL FIELD

This disclosure relates in general to sanding and polishing, and more particularly to systems and methods for low temperature sanding and polishing.

### BACKGROUND

Polishing or sanding a target material generates heat and raises the temperature of the target material. Typically, polishing or sanding the target material when the material is in its glass state or within its glass transition temperature reduces the risk of ripping the target material at a molecular level. Most plastics and metals have a high glass transition state, or temperature, so the heat generated from friction does not affect the quality of the polishing or sanding.

However, some materials such as special paints, soft plastics, and coatings have a glass transition state that is below room temperature. Any added heat above the glass transition state, or temperature, increases the possibility of the material ripping instead of being cut. Friction still generates heat when sanding or polishing at low RPM speeds, so maintaining a low temperature of the target material is very difficult.

Previous cooling methods of the target material include using a cold air blower, a dry ice chamber, or placing the material in a walk-in freezer. The problem with these methods is the heat from friction is directly below the polishing pad, blocking any cold air or gas that is attempting to cool the area. The area surrounding the polishing area is being constantly cooled, but the desired polishing area is not receiving any cold fluid. Cold environments that apply cold air or gas can also be a hazardous working environment for the worker, having potential problems such as reduced sanding skills, frostbite, and hypothermia.

Other problems occur when polishing or sanding materials with a lower glass transition temperature. When sanding or polishing with abrasive grit sizes or at high speeds, a larger amount of heat is generated. For example, when automotive shops are polishing paint, operators must take frequent breaks to ensure the paint does not get too hot. Otherwise, the operators could delaminate the paint, wear out the polishing pad quickly, and dry out the polishing compound.

Previous attempts to solve this problem, for example European Patent No. 0391148 B1, involved injecting liquid nitrogen or liquid carbon dioxide into a rotating polishing pad to polish special automotive paints at extremely low temperatures. The use of liquid nitrogen or liquid carbon dioxide made the device larger and unwieldy. Using liquid nitrogen or carbon dioxide also required expensive tooling that decreased the affordability of the device. Finally, the very cold temperatures of liquid nitrogen increased the risk of injury to the operator of the device.

### SUMMARY

In some embodiments, a method for removing a defect from an aircraft transparency includes preparing an apparatus that is operable to cool a surface during sanding and polishing operations. The method further includes performing a first sanding procedure on the aircraft transparency using the apparatus and a first sanding pad coupled to the apparatus. The method further includes performing a second sanding procedure on the aircraft transparency using the apparatus if the defect is removed by the first sanding procedure, wherein the second sanding procedure utilizes a second sanding pad coupled to the apparatus that has a higher grit value than the first sanding pad. The method further includes performing, using the apparatus, a first polishing procedure on the aircraft transparency in order to remove sanding marks on the aircraft transparency from a previous sanding procedure, wherein the first polishing procedure utilizes a first polishing pad coupled to the apparatus and a first polishing paste applied to the first polishing pad. The method further includes performing a second polishing procedure on the aircraft transparency using the apparatus if the first polishing procedure removes all sanding marks on the aircraft transparency from the previous sanding procedure, wherein the second polishing procedure utilizes a second polishing pad coupled to the apparatus and a second polishing paste applied to the second polishing pad. The second polishing paste has a lower micron value than the first polishing paste.

In some embodiments, the method further includes performing a third sanding procedure on the aircraft transparency using the apparatus if the second sanding procedure removes all sanding marks on the aircraft transparency from the first sanding procedure, wherein the third sanding procedure utilizes a third sanding pad coupled to the apparatus that has a higher grit value than the second sanding pad.

In some embodiments, the method further includes performing a third polishing procedure on the aircraft transparency using the apparatus if the second polishing procedure removes all polishing marks on the aircraft transparency from the first polishing procedure, wherein the third polishing procedure utilizes a third polishing pad coupled to the apparatus and a third polishing paste applied to the third polishing pad. The third polishing paste has a lower micron value than the second polishing paste.

In some embodiments, a method for removing a defect from a surface includes performing a first sanding procedure on the surface using an apparatus and a first sanding pad coupled to the apparatus. The apparatus is operable to cool the surface during sanding and polishing operations. The method further includes performing a second sanding procedure on the surface using the apparatus if the defect is removed by the first sanding procedure, wherein the second sanding procedure utilizes a second sanding pad coupled to the apparatus that has a higher grit value than the first sanding pad. The method further includes performing, using the apparatus, a first polishing procedure on the surface in order to remove sanding marks on the surface from a previous sanding procedure, wherein the first polishing procedure utilizes a first polishing pad coupled to the apparatus and a first polishing paste applied to the first polishing pad. The method further includes performing a second polishing procedure on the surface using the apparatus if the first polishing procedure removes sanding marks on the surface from the previous sanding procedure, wherein the second polishing procedure utilizes a second polishing pad coupled to the apparatus and a second polishing paste applied to the second polishing pad. The second polishing paste has a lower micron value than the first polishing paste.

In some embodiments, the method further includes performing a third sanding procedure on the surface using the apparatus if the second sanding procedure removes all sanding marks on the surface from the first sanding procedure, wherein the third sanding procedure utilizes a third sanding pad coupled to the apparatus that has a higher grit value than the second sanding pad.

In some embodiments, the method further includes performing a third polishing procedure on the surface using the apparatus if the second polishing procedure removes all polishing marks on the surface from the first polishing procedure, wherein the third polishing procedure utilizes a third polishing pad coupled to the apparatus and a third polishing paste applied to the third polishing pad. The third polishing paste has a lower micron value than the second polishing paste.

Technical advantages of certain embodiments may include systems and methods for removing a defect from a surface, and in particular removing defects from surfaces that have a glass transition state that is below room temperature (e.g., resin surfaces such as aircraft canopy transparencies). By utilizing the disclosed systems and methods, defects within components such as aircraft transparencies may be quickly, efficiently, and effectively repaired—an option that is not currently available with existing technology. The disclosed systems and methods can significantly reduce the optical distortion caused by minor defects or damage and can decrease the size and appearance of larger defects. In some embodiments, the disclosed processes can be automated using a robotic arm—significantly reducing the time required to repair sensitive surfaces such as resin surfaces of aircraft canopy transparencies.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present disclosure and its advantages, reference is now made to the following descriptions taken in conjunction with the accompanying drawings, in which:

FIG. 1A illustrates an example of previous cooling methods that required a surface to be cooled externally from the sanding or polishing device.

FIG. 1B illustrates a cross-section of a surface implementing the cooling using a sanding or polishing apparatus, according to certain embodiments.

FIG. 2 illustrates an assembled sanding or polishing apparatus, according to certain embodiments.

FIG. 3 illustrates a disassembled view of a sanding or polishing apparatus, according to certain embodiments.

FIG. 4A illustrates a first view of a sanding housing and a sander, according to certain embodiments.

FIG. 4B illustrates a second view of a sanding housing and a sander, according to certain embodiments.

FIG. 5 illustrates a partially assembled sanding or polishing apparatus, according to certain embodiments.

FIG. 6 illustrates a sanding head with and without a sanding pad, according to certain embodiments.

FIG. 7 is a chart illustrating a method for removing a defect from a surface using the apparatus of FIG. 2, according to particular embodiments.

FIG. 8 is a chart illustrating a first sanding procedure of the method of FIG. 7, according to particular embodiments.

FIG. 9 is a chart illustrating a second sanding procedure of the method of FIG. 7, according to particular embodiments.

FIG. 10 is a chart illustrating a third sanding procedure of the method of FIG. 7, according to particular embodiments.

FIG. 11 is a chart illustrating a first polishing procedure of the method of FIG. 7, according to particular embodiments.

FIG. 12 is a chart illustrating a second polishing procedure of the method of FIG. 7, according to particular embodiments.

FIG. 13 is a chart illustrating a third polishing procedure of the method of FIG. 7, according to particular embodiments.

It should be understood that the drawings are not necessarily to scale and that the disclosed embodiments are sometimes illustrated diagrammatically and in partial views. In certain instances, details which are not necessary for an understanding of the disclosed methods and apparatuses or which render other details difficult to perceive may have been omitted. It should be understood, of course, that this disclosure is not limited to the particular embodiments illustrated herein.

### DETAILED DESCRIPTION

The disclosure presented in the following written description and the various features and advantageous details thereof, are explained more fully with reference to the non-limiting examples included in the accompanying drawings and as detailed in the description. Descriptions of well-known components have been omitted to not unnecessarily obscure the principal features described herein. The examples used in the following description are intended to facilitate an understanding of the ways in which the disclosure can be implemented and practiced. A person of ordinary skill in the art would read this disclosure to mean that any suitable combination of the functionality or exemplary embodiments below could be combined to achieve the subject matter claimed. The disclosure includes either a representative number of species falling within the scope of the genus or structural features common to the members of the genus so that one of ordinary skill in the art can recognize the members of the genus. Accordingly, these examples should not be construed as limiting the scope of the claims.

A person of ordinary skill in the art would understand that any system claims presented herein encompass all of the elements and limitations disclosed therein, and as such, require that each system claim be viewed as a whole. Any reasonably foreseeable items functionally related to the claims are also relevant. The Examiner, after having obtained a thorough understanding of the disclosure and claims of the present application has searched the prior art as disclosed in patents and other published documents, i.e., nonpatent literature. Therefore, as evidenced by issuance of this patent, the prior art fails to disclose or teach the elements and limitations presented in the claims as enabled by the specification and drawings, such that the presented claims are patentable under the applicable laws and rules of this jurisdiction.

As described above, polishing or sanding a target material generates heat and raises the temperature of the target material. Typically, polishing or sanding the target material when the material is in its glass state or below the glass transition temperature of the material reduces the risk of ripping the target material at a molecular level. Most plastics and metals have a high glass transition state, or temperature, so the heat generated from friction does not affect the quality of the polishing or sanding.

The present disclosure may provide numerous technical advantages. For example, certain embodiments cool a target surface while the apparatus is sanding or polishing instead of cooling the surround area of the target surface. In this manner, the operator of the device is able to continue sanding or polishing without raising the temperature of the target surface allowing longer operational periods.

Other technical advantages will be readily apparent to one skilled in the art from the following figures, descriptions, and claims. Moreover, while specific advantages have been enumerated above, various embodiments may include all, some, or none of the enumerated advantages.

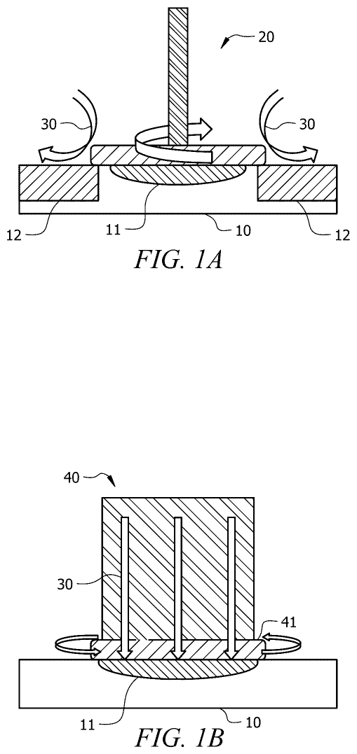

FIG. 1A illustrates a previous method of cooling a surface 10 during polishing or sanding, which may also be referred to as a target surface, material, or target material. The previous method of cooling included using a conventional sander or polisher 20, such as an orbital sander, to polish the target surface 10, including target area 11. The conventional sander 20 would generate heat from friction in the target area 11 during operation of sander 20. The heat generated would lead to damaging the material 10, so the previous method would introduce cooling fluid 30 to the target surface 10. However, as can be seen in FIG. 1A, the cooling fluid 30 would be introduced external to the conventional sander or polisher 20 and would cool the material 10 in external areas 12 but would fail to cool the target area 11 where the conventional sander 20 is generating heat in the material 10.

FIG. 1B illustrates a cross-section of the surface 10 during sanding or polishing utilizing an apparatus according to embodiments of the present disclosure. As shown in FIG. 1B, a sander or polisher 40, according to certain embodiments, would sand or polish the target area 11 of the material 10. As shown in FIG. 1B, a sanding head 41 contacts the target 11 of the material 10 during operation of the sander or polisher 40. The sanding head 41, may also be, for example, a polishing head, a buffing head, etc. According to certain embodiments, the cooling fluid 30 may pass through the sanding head 41 to cool the target area 11 of the material 10 during operation of the sander or polisher 40. The cooling fluid 30, according to certain embodiments, is applied directly to a location where the sanding head 41 is generating heat through friction. This direct application allows the operator of the sander or polisher 40 to work continuously without damaging the material 10. Additionally, the external cooling described in FIG. 1A, requires the operator to work in dangerous working conditions, such as working in a walk-in freezer, or using hazardous cooling fluids, such as liquid nitrogen, to achieve the necessary cooling to maintain the target area 11 at temperature below the glass transition temperature of the material 10. Material 10 may include any material that requires sanding or polishing having a glass transition temperature below room temperature, or approximately 70 degrees Fahrenheit, for example certain plastics, paints, and material coatings. Another advantage to the cooling fluid 30 passing through the sanding head 41 is reducing the wear of a sanding or polishing pad (not shown in FIG. 1B) attached to the sanding head 41 due to the heat generated from friction, which can burn the sanding or polishing pad.

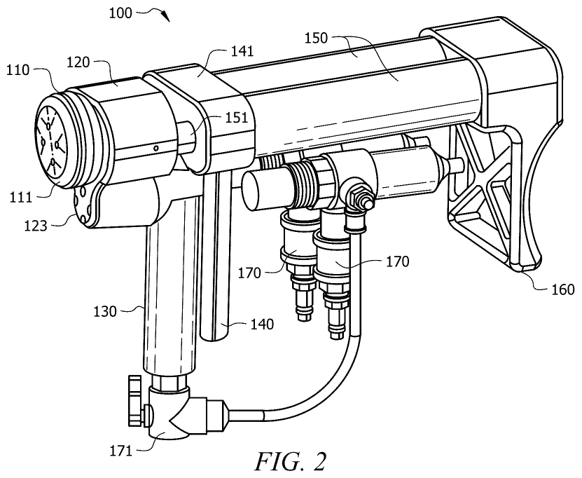

FIG. 2 illustrates an exemplary embodiment of an apparatus 100 for sanding or polishing a surface or material. According to the exemplary embodiment, apparatus 100 may include a sanding head 110 for sanding or polishing the target surface or material. The apparatus 100 may include a sanding housing 120 connected to the sanding head 110 and to a sander or polisher 130. The apparatus 100 may also include a handle 140 that may be connected to the sander or polisher 130. The apparatus 100 may also include at least one fluid supply source that may include at least one cooling fluid device 150. According to this exemplary embodiment, the at least one fluid supply includes two cooling fluid devices 150, but any number of cooling fluid devices 150 are contemplated, as well as any number of fluid supply sources. The at least one cooling fluid device 150 may be connected to the handle 140. The at least one cooling fluid device may also be connected to a second handle 160. At least one fluid supply line 151 may fluidly connect the at least one cooling fluid device 150 to the sanding housing 120 so that a cooling fluid may flow from the at least one cooling fluid device to the sanding head 110. According to this exemplary embodiment, the at least one fluid supply includes fluid supply lines.

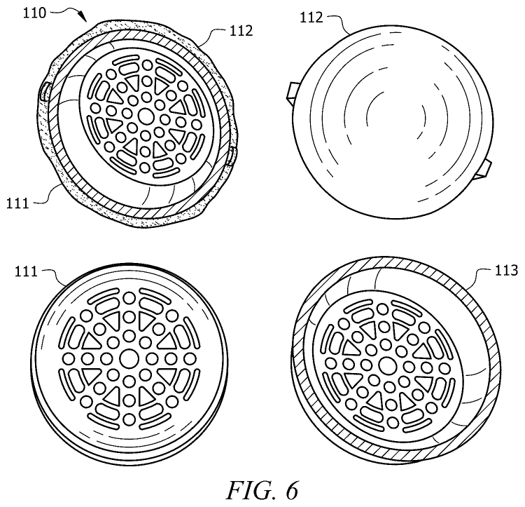

The sanding head 110 may include a sanding head support structure 111 and a sanding pad (not shown in FIG. 2). The sanding head support structure 111 is discussed further below in reference to FIG. 6. As shown in FIG. 2, the sanding head 110 may be cylindrical in shape. In certain embodiments, the sanding head 110 may have a spherical shape, a conical shape, a rectangular shape, or any other shape suitable for sanding or polishing a surface.

In certain embodiments, the sanding head 110 may be removably attached to a sanding housing 120. The sanding head 110 may be configured to receive a cooling fluid at a first end and exhaust a fluid at a second end. For example, the sanding head 110 may be fluidly connected to the sanding housing 120 and the cooling fluid flows from the sanding housing 120 to the sanding head 110. In an alternative embodiment, the sanding head 110 may be fluidly connected directly to one or more fluid supply lines 151. The sanding head 110 may define a fluid flow axis passing through the center of the sanding head 110. The fluid flow axis may be substantially orthogonal to the target surface or material that the apparatus is sanding or polishing. Substantially orthogonal, according to the exemplary embodiment, may be defined as orthogonal relative to a point of contact between the sanding pad of the sanding head 110 and the target surface. The target surface or material may be concave in shape or may be substantially flat in shape. In the exemplary embodiment when the target surface or material is concave in shape, the fluid flow axis may be substantially parallel to the radius of curvature of the target surface or material.

According to the exemplary embodiment shown in FIG. 2, the sanding head 110 may be attached to the sanding housing 120. The sanding housing 120 may be removably attached to a sander or polisher 130. For example, the sanding housing 120 may include a flange 123 configured to removably attach the sander or polisher 130.

In certain embodiments, the sanding housing 120 may include one or more fluid inlets (not shown in FIG. 2) configured to receive a cooling fluid. The one or more fluid supply lines 151 may be removably attached to the one or more fluid inlets.

In certain embodiments, the sanding head 110 may be removably attached to the sander or polisher 130. The sander or polisher 130 may be removably attached to a handle 140. In certain embodiments, the sander or polisher 130 may be structurally integrated into the apparatus 100 such that the sander or polisher 130 is not removably attached. The sander or polisher 130 may be an orbital sander or polisher, or a random orbital sander or polisher. The sander or polisher 130 may be powered by pneumatics or electrical power. The sander may have a motor. The motor may be a pneumatic motor or an electrical motor. The sander or polisher 130 may be an off-the-shelf product, for example, the 3M™ Elite Mini Orbital Sander. The apparatus is not limited to use of the identified off-the shelf-products as it is contemplated that most sanders could be used with the apparatus 100.

In certain embodiments, the sander or polisher 130 may be connected to one or more pneumatic fittings 170, to power the sander or polisher 130. The sander or polisher 130 may be connected to the one or more pneumatic fittings by a pneumatic connection port 171. The one or more pneumatic fittings 170 may be removably attached to the apparatus 100. The one or more pneumatic fittings may be removably attached to the handle 140. The one or more pneumatic fittings may be removably attached to the at least one cooling fluid devices 150. The one or more pneumatic fittings 170 may be removably attached to the second handle 160. The one or more pneumatic fittings 170 may be fluidly connected to one or more cooling fluid devices 150.

In certain embodiments, the second handle 160, may provide support to the one or more cooling fluid devices. The second handle 160, as shown in FIG. 2 for example, may be in the form of a structural guard to prevent hitting the one or more pneumatic fittings 170, as well as configured to provide support for the shoulder of the operator.

In certain embodiments, the at least one fluid supply source may include the at least one cooling fluid devices 150. According to an exemplary embodiment, the cooling fluid device 150 may be a vortex tube that is connected to a compressed air supply line which cools compressed air below the glass transition temperature of the material to be sanded. However, it is contemplated that the cooling fluid device 150 could be the fluid supply source for the apparatus where the cooling fluid device both stores and cools the fluid used for cooling. The cooling fluid may be, for example, compressed air, coolant, or other non-hazardous refrigerants. According to an exemplary embodiment, the cooling fluid is compressed air. In certain embodiments, the apparatus 100 may not include the cooling fluid device 150 but would receive the cooling fluid from the fluid supply source.

In certain embodiments, the at least one cooling fluid device 150 may be removably connected to the handle 140. The handle 140 may have a handle head 141 configured to connect the handle 140 to the at least one cooling fluid device 150. The handle head 141 may also provide structural support for the at least one cooling fluid device. The handle head 141 may also be configured to receive the at least one fluid supply line 151. The at least one fluid supply line 151 may be fluidly connected to the at least one cooling fluid device. For example, the at least one fluid supply line 151 may be tubing connected to the at least one cooling fluid device 150. Any suitable material for transferring fluid flow may be used for the at least one fluid supply line 151. The at least one fluid supply line 151 may be contained within at least either the handle head 141 or the sanding housing 120. In certain embodiments, the at least one fluid supply line may be a fluid flow path within the handle head 141 or the sanding housing 120.

In certain embodiments, the sander 130 may be removably attached to the handle 140. In certain embodiments, the handle 140 may be combined with the sanding housing 120 such that the handle 140 and the sanding housing 120 are a single piece.

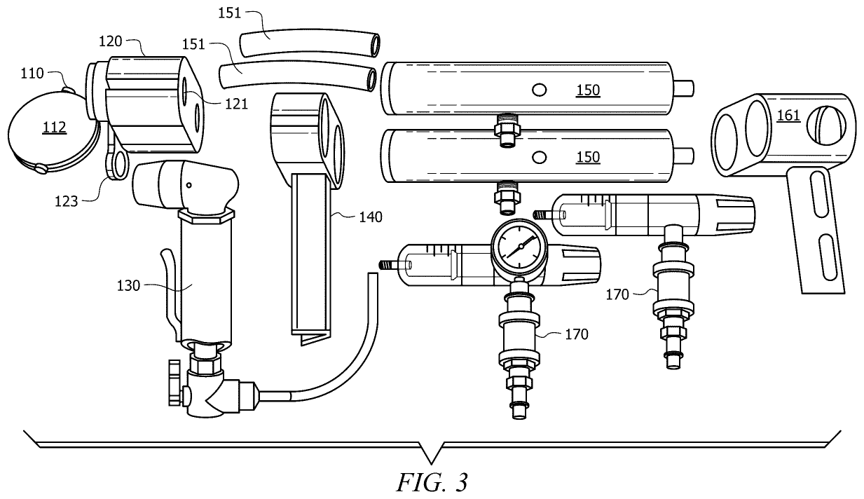

FIG. 3 illustrates an alternative exemplary embodiment of the apparatus 100 for sanding or polishing a surface or material, where the apparatus 100 is disassembled. According to the exemplary embodiment, the sanding housing 120 may include at least one housing inlet 121 configured to receive the at least one fluid supply line 151. The at least one housing inlet may also form a fluid flow path to receive cooling fluid from the at least one cooling fluid device 150.

In certain embodiments, the sanding head 110 may include the sanding pad 112. The sanding pad 112, may be a polishing pad, or any other material suitable for sanding, polishing, or buffing. The sanding pad 112 may be porous such that the sanding pad 112 allows fluid flow to pass through the sanding pad 112.

As shown in FIG. 3, the apparatus 100 can be a modular device that can be customized to fit the needs of the operator. In certain embodiments, the apparatus 100 may include an alternative second handle 161 that includes a handle grip for the operator to hold while using the device.

The modular design of the apparatus 100, according to the exemplary embodiment of FIG. 3, is a non-limiting exemplary design. In certain embodiments, the apparatus 100 may be arranged such that the sanding housing 120, the sander 130, the handle 140, the at least one fluid supply line 151, and the second handle 161 are structurally connected such that the apparatus 100 is one structural piece. According to this embodiment, the sanding head 110, the at least one cooling fluid device 150, and the pneumatic fitting 170 may be removable. It is contemplated that all components of the apparatus 100 may be structurally connected and only the sanding pad 112 may be replaceable.

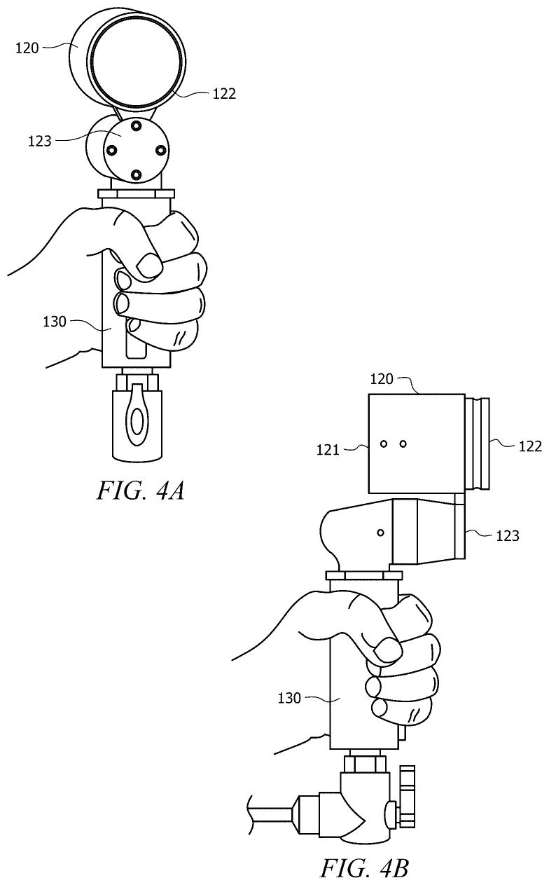

FIGS. 4A and 4B illustrate an exemplary embodiment of the sanding housing 120 and the connection of the sanding housing 120 to the sander 130. In certain embodiments, the sanding housing 120 may include the flange 123. The sanding housing 120 may be removably connected to the sander 130 via the flange 123. The flange 123 may be connected to the sander 130 by bolts, screws, or other suitable fixtures.

In certain embodiments, the sanding housing 120 may include a housing outlet 122. The housing outlet 122 may be configured to allow the cooling fluid to pass through the sanding housing 120 to the sanding head 110. The sanding head may also include at least one housing inlet 121. The sanding housing 120 may be configured to allow fluid flow to pass from the at least one housing inlet 121 to the housing outlet 122. The housing outlet 122 may be configured to removably connect to the sanding head 110. The housing outlet 122 may have a center defining a fluid flow axis. For example, according to the exemplary embodiment, the housing outlet 122 may be circular shape such that the center of the circular shape defines the center of the housing outlet 122. The fluid flow axis may pass through the center of the housing outlet 122 such that the fluid flow axis passes through the center of the sanding head 110 and is relatively orthogonal to the surface or material to be sanded or polished.

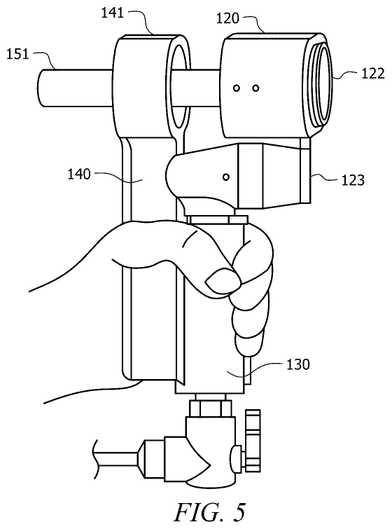

FIG. 5 illustrates an exemplary embodiment showing the partial assembly of the sanding housing 120, the sander 130, the handle 140, and the at least one fluid supply line 151. In certain embodiments, the sanding housing 120 may be axially aligned with the handle head 141 and the at least one fluid supply line 151 such that the handle head 141 and the at least one fluid supply line 151 are axially aligned with the fluid flow axis defined by the housing outlet 122.

FIG. 6 illustrates exemplary embodiments of the sanding head 110. In certain embodiments, sanding head 110 may include the sanding pad support structure 111 and the sanding pad 112. The sanding pad support structure 111 may be circular in shape and configured to connect to the housing outlet 122. The sanding pad support structure 111 may be configured to all flow fluid to travel from the housing outlet 122 to the sanding pad 112. The sanding pad support structure 111 may include a particulate filter 113. In certain embodiments, the particulate filter 113 may be aerated, or otherwise configured, to capture solid particulate while allowing the cooling fluid to pass through the particulate filter. For example, the particulate filter 113 may be integrated into the sanding pad support structure 111 such that the sanding pad support structure 111 may be aerated, or may include a plurality of holes, to capture solid particulate. The solid particulate may include ice generated by the cooling fluid, or any other solid particulate that may accumulate. In certain embodiments, the particulate filter 113 may be removably attached to the sanding pad support structure 111.

In certain embodiments, the sanding pad 112 may be abrasive pads that are suitable for sanding a surface. The sanding pad 112 may also pads that are suitable for polishing a surface. The sanding pad 112 may be porous such that the cooling fluid passes through to the target surface or material.

In some embodiments, surface 10 may be a resin surface. For example, surface 10 may be a polyurethane resin surface that is applied to a transparency of an aircraft canopy (e.g., an outer mold line). In general, it is difficult or practically impossible to repair a defect in a resin surface such as a polyurethane resin surface of an aircraft transparency without leaving optical distortions behind. This is because the resin must be machined below its glass transition temperature of 55 degrees Fahrenheit or else the resin will be damaged—a feat that is impractical, time consuming, ineffective, or cost-prohibitive with current tools and processes. For example, when a minor optical defect (MOD) occurs in an aircraft transparency, the main repair method available is a complex strip-and-recoat process that may take upwards of three weeks to complete. This process uses harsh chemicals to strip the material, which is dangerous to workers and thereby increases costs and the amount of time required to complete the process. Furthermore, the recoat process is the same process that created the MOD in the first place, potentially leaving another MOD in another location on the same transparency. Importantly, an aircraft transparency usually may only be striped and recoated a limited number of times (e.g., three) and must be scrapped after this limit is reached.

In addition, accidental damage to a surface such as a polyurethane resin surface of any aircraft transparency may occur during the manufacturing or assembly process of the aircraft. Such damage most often occurs from tools accidentally being dropped onto the transparency, paint accidentally dripping onto the transparency, personal items accidentally bumping or scratching the transparency, and the like. If the damage is assessed to be too great or if the damage obstructs the pilot's view, the canopy must be disassembled, and the transparency must be shipped back to the supplier to be repaired (e.g., stripped and recoated as described above). This causes disruptions and delays in the manufacturing/assembly process of the aircraft.

Once an aircraft is in service, damage to a canopy transparency is typically repaired in the field. For example, mechanics typically sand the defective area, apply a small amount of repair resin, and then cover the repaired area with a fluorinated ethylene propylene (FEP) film until cured. Once repaired, the repair resin and defect are still visible to the pilot—an undesirable and potentially unsafe situation for pilots.

To address these and other problems with repairing defects in a surface 10 such as a polyurethane resin surface of an aircraft canopy transparency, the disclosed embodiments provide systems and methods for removing a defect from a surface using low temperature sanding and polishing. Instead of existing processes to repair defects such as complex strip-and-recoat processes and field-applied repair resins as described above, the disclosed processes utilize apparatus 100 that is able to cool a surface during sanding and polishing operations, thereby keeping the surface below its glass transition temperature. This prevents damage to the surface and enables efficient and effective repair operations to objects such as aircraft canopy transparencies that would otherwise be impossible.

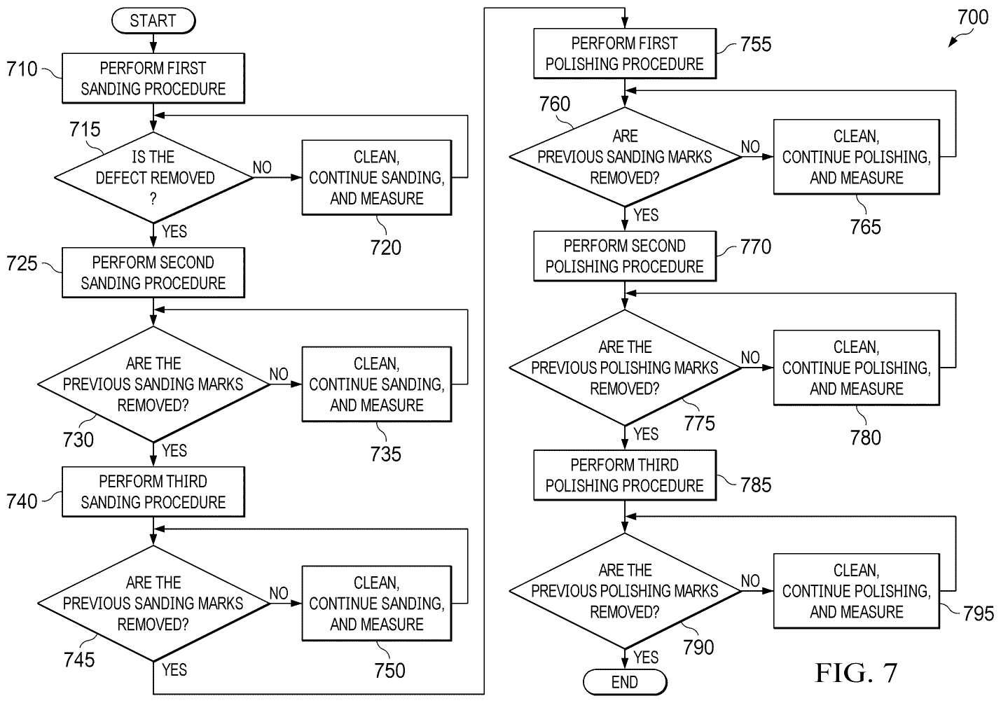

FIG. 7 is a chart illustrating a method 700 for removing a defect from a surface, according to particular embodiments. In some embodiments, method 700 may be performed using apparatus 100 of FIG. 2. In some embodiments, method 700 may be performed on a resin surface such as a polyurethane resin surface that is applied to a transparency of an aircraft canopy.

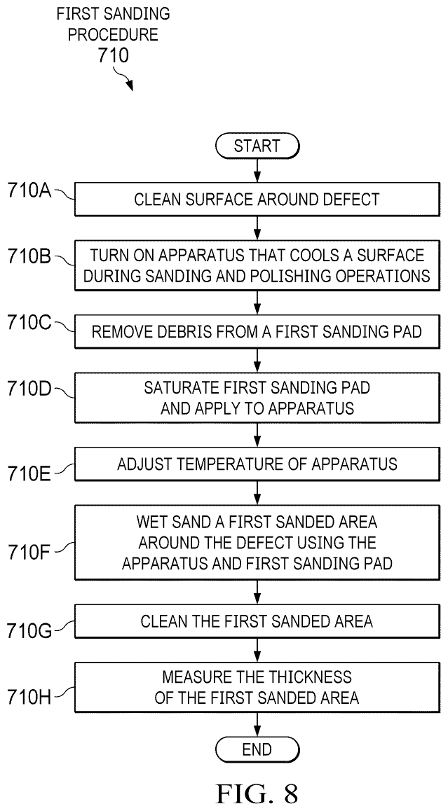

At step 710, method 700 performs a first sanding procedure on the surface using an apparatus that is able to cool the surface during sanding and polishing operations (e.g., apparatus 100). In some embodiments, the first sanding procedure of step 710 is performed using a first sanding pad coupled to the apparatus. In general, the first sanding procedure of step 710 uses a low-grit sanding pad to remove the defect from the surface. A particular embodiment of step 710 is illustrated in FIG. 8 and discussed in more detail below.

At step 715, method 700 determines whether the defect was removed from the surface in step 710. If it is determined in step 715 that the defect was removed from the surface by the first sanding procedure of step 710, method 700 proceeds to step 725. Otherwise, if it is determined in step 715 that the defect was not removed from the surface by the first sanding procedure of step 710 (i.e., the defect is still visible), method 700 proceeds to step 720. Any appropriate method may be utilized in step 715 to determine if the defect was removed from the surface. If method 700 is performed at least partially by an operator, the operator may visually inspect the surface in order to determine if the defect has been removed. In other embodiments, any computerized visual analysis technique may be utilized to determine in step 715 if the defect was removed from the surface (e.g., using an imaging device such as a camera and any appropriate image analysis software or technique).

At step 720, method 700 repeats one or more steps of step 710 in order to attempt to remove the defect from the surface. For example, in some embodiments, step 720 includes first cleaning the surface (e.g., the first sanded area described in FIG. 8) using any appropriate materials (e.g., deionized water and a cheese cloth). Next, method 700 may continue to sand the surface in step 720 using the first sanding pad of step 710 for a predetermined amount of additional time (e.g., for two minutes) or until the defect has been removed. In some embodiments, method 700 may additionally measure the thickness of the sanded area (e.g., the first sanded area of FIG. 8) to ensure that the thickness stays within engineering tolerances (e.g., is equal to or greater than a minimum thickness). If the measured thickness of the polished area is found to be at or below a minimum thickness, method 700 may end. After step 720, method 700 returns to step 715 in order to determine if the defect was removed from the surface.

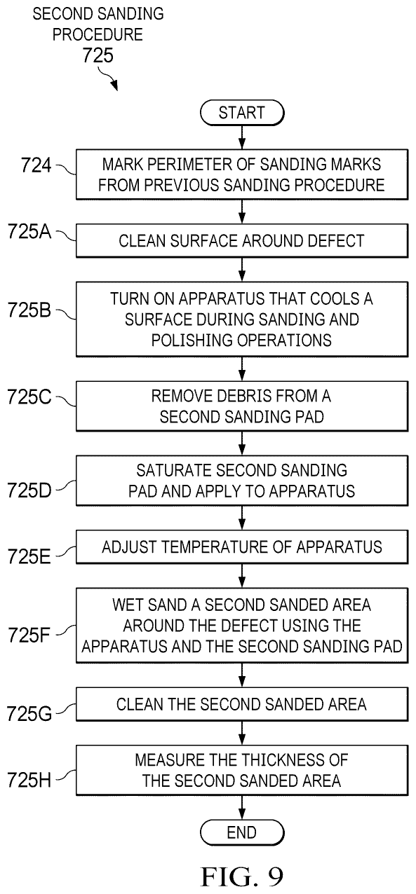

At step 725, method 700 performs a second sanding procedure on the surface using the apparatus that is able to cool the surface during sanding and polishing operations (e.g., apparatus 100). In some embodiments, the second sanding procedure of step 725 is performed using a second sanding pad coupled to the apparatus. In general, the second sanding procedure of step 725 uses a sanding pad with a higher grit value than the sanding pad used in the first sanding procedure of step 710 in order to remove the sanding marks left on the surface from the first sanding procedure of step 710. A particular embodiment of step 725 is illustrated in FIG. 9 and discussed in more detail below.

At step 730, method 700 determines whether the sanding marks left on the surface from the first sanding procedure of step 710 were removed by the second sanding procedure of step 725. If it is determined in step 730 that the sanding marks left on the surface from the first sanding procedure of step 710 were removed by the second sanding procedure of step 725, method 700 proceeds to step 740. Otherwise, if it is determined in step 730 that the sanding marks left on the surface from the first sanding procedure of step 710 were not completely removed by the second sanding procedure of step 725 (i.e., the sanding marks are still visible), method 700 proceeds to step 735. Any appropriate method may be utilized in step 730 to determine if the sanding marks left on the surface from the first sanding procedure of step 710 were completely removed by the second sanding procedure of step 725. If method 700 is performed at least partially by an operator, the operator may visually inspect the surface in order to determine if the sanding marks have been removed. In other embodiments, any computerized visual analysis technique may be utilized in step 730 to determine if the sanding marks have been removed (e.g., using an imaging device such as a camera and any appropriate image analysis software or technique).

At step 735, method 700 repeats one or more steps of step 725 in order to attempt to remove the sanding marks left on the surface from the first sanding procedure of step 710. For example, in some embodiments, step 735 includes first cleaning the surface (e.g., the second sanded area described in FIG. 9) using any appropriate materials (e.g., deionized water and a cheese cloth). Next, method 700 may continue to sand the surface in step 735 using the second sanding pad of step 725 for a predetermined amount of additional time (e.g., for five minutes). In some embodiments, method 700 may additionally measure the thickness of the sanded area (e.g., the second sanded area of FIG. 9) to ensure that the thickness stays within engineering tolerances (e.g., is equal to or greater than a minimum thickness). If the measured thickness of the polished area is found to be at or below a minimum thickness, method 700 may end. After step 735, method 700 returns to step 730 in order to determine whether the sanding marks left on the surface from the first sanding procedure of step 710 were removed.

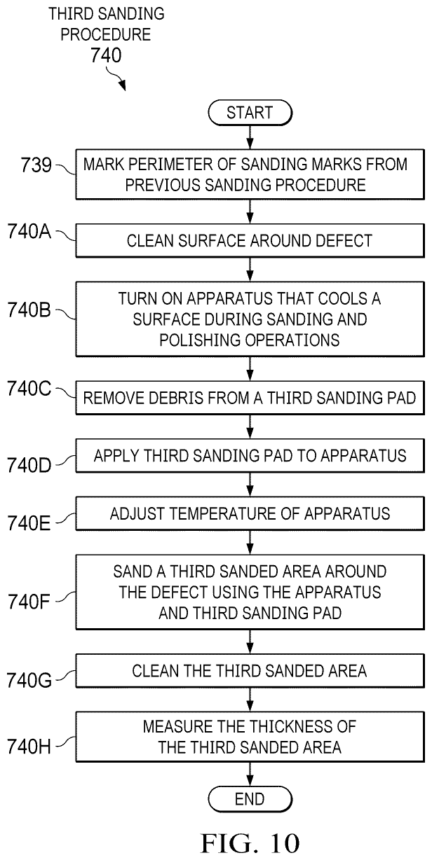

At step 740, method 700 performs a third sanding procedure on the surface using the apparatus that is able to cool the surface during sanding and polishing operations (e.g., apparatus 100). In some embodiments, the third sanding procedure of step 740 is performed using a third sanding pad coupled to the apparatus. In general, the third sanding procedure of step 740 uses a sanding pad with a higher grit value than the sanding pad used in the second sanding procedure of step 725 in order to remove the sanding marks left on the surface from the second sanding procedure of step 725. A particular embodiment of step 740 is illustrated in FIG. 10 and discussed in more detail below.

At step 745, method 700 determines whether the sanding marks left on the surface from the second sanding procedure of step 725 were removed by the third sanding procedure of step 740. If it is determined in step 745 that the sanding marks left on the surface from the second sanding procedure of step 725 were removed by the third sanding procedure of step 740, method 700 proceeds to step 755. Otherwise, if it is determined in step 745 that the sanding marks left on the surface from the second sanding procedure of step 725 were not completely removed by the third sanding procedure of step 740 (i.e., the sanding marks are still visible), method 700 proceeds to step 750. Any appropriate method may be utilized in step 745 to determine if the sanding marks left on the surface from the second sanding procedure of step 725 were completely removed by the third sanding procedure of step 740. If method 700 is performed at least partially by an operator, the operator may visually inspect the surface in order to determine if the sanding marks have been removed. In other embodiments, any computerized visual analysis technique may be utilized in step 745 to determine if the sanding marks have been removed (e.g., using an imaging device such as a camera and any appropriate image analysis software or technique).

At step 750, method 700 repeats one or more steps of step 740 in order to attempt to remove the sanding marks left on the surface from the second sanding procedure of step 725. For example, in some embodiments, step 750 includes first cleaning the surface (e.g., the third sanded area described in FIG. 10) using any appropriate materials (e.g., deionized water and a cheese cloth). Next, method 700 may continue to sand the surface in step 750 using the third sanding pad of step 740 for a predetermined amount of additional time (e.g., for ten minutes). In some embodiments, method 700 may additionally measure the thickness of the sanded area (e.g., the third sanded area of FIG. 10) to ensure that the thickness stays within engineering tolerances (e.g., is equal to or greater than a minimum thickness). If the measured thickness of the polished area is found to be at or below a minimum thickness, method 700 may end. After step 750, method 700 returns to step 745 in order to determine whether the sanding marks left on the surface from the second sanding procedure of step 725 were removed.

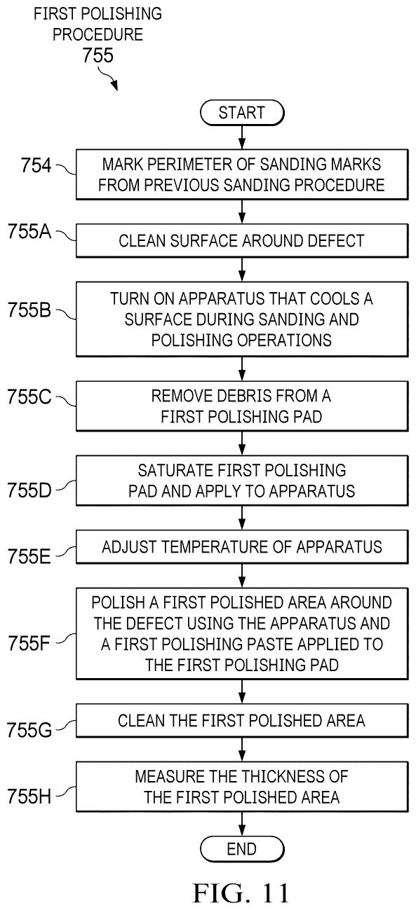

At step 755, method 700 performs a first polishing procedure on the surface using the apparatus that is able to cool the surface during sanding and polishing operations (e.g., apparatus 100). In some embodiments, the first polishing procedure of step 755 is performed using a first polishing pad coupled to the apparatus and a first polishing paste applied to the first polishing pad. In general, the first polishing procedure of step 755 uses a polishing paste with a high micron value (e.g., four micron) in order to polish away the sanding marks left on the surface from the previous sanding procedure (e.g., the third sanding procedure of step 740). A particular embodiment of step 755 is illustrated in FIG. 11 and discussed in more detail below.

At step 760, method 700 determines whether the sanding marks left on the surface from the third sanding procedure of step 740 were removed by the first polishing procedure of step 755. If it is determined in step 760 that the sanding marks left on the surface from the third sanding procedure of step 740 were removed by the first polishing procedure of step 755, method 700 proceeds to step 770. Otherwise, if it is determined in step 760 that the sanding marks left on the surface from the third sanding procedure of step 740 were not completely removed by the first polishing procedure of step 755 (i.e., the sanding marks are still visible), method 700 proceeds to step 765. Any appropriate method may be utilized in step 760 to determine if the sanding marks left on the surface from the third sanding procedure of step 740 were completely removed by the first polishing procedure of step 755. If method 700 is performed at least partially by an operator, the operator may visually inspect the surface in order to determine if the sanding marks have been removed. In other embodiments, any computerized visual analysis technique may be utilized in step 760 to determine if the sanding marks have been removed (e.g., using an imaging device such as a camera and any appropriate image analysis software or technique).

At step 765, method 700 repeats one or more steps of step 755 in order to attempt to remove the sanding marks left on the surface from the third sanding procedure of step 740. For example, in some embodiments, step 765 includes first cleaning the surface (e.g., the first polished area described in FIG. 11) using any appropriate materials (e.g., deionized water and a cheese cloth). Next, method 700 may continue to polish the surface in step 765 using the first polishing paste of step 755 for a predetermined amount of additional time (e.g., for thirty minutes). In some embodiments, method 700 may additionally measure the thickness of the polished area of the surface (e.g., the first polished area of FIG. 11) to ensure that the thickness of the surface stays within engineering tolerances (e.g., is equal to or greater than a minimum thickness). If the measured thickness of the polished area is found to be at or below a minimum thickness, method 700 may end. After step 765, method 700 returns to step 760 in order to determine whether the sanding marks left on the surface from the third sanding procedure of step 740 were removed.

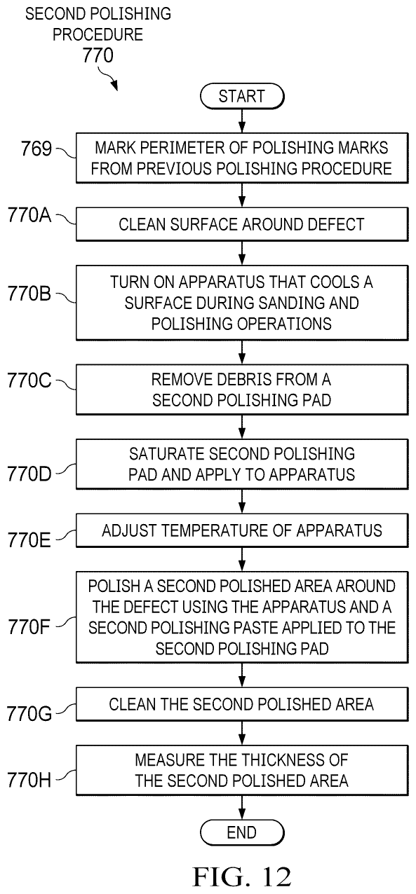

At step 770, method 700 performs a second polishing procedure on the surface using the apparatus that is able to cool the surface during sanding and polishing operations (e.g., apparatus 100). In some embodiments, the second polishing procedure of step 770 is performed using a second polishing pad coupled to the apparatus and a second polishing paste applied to the second polishing pad. In general, the second polishing procedure of step 770 uses a polishing paste with a lower micron value (e.g., two micron) than the first polishing paste of step 755 in order to polish away any polishing marks left on the surface from the first polishing procedure of step 755. A particular embodiment of step 770 is illustrated in FIG. 12 and discussed in more detail below.

At step 775, method 700 determines whether the polishing marks left on the surface from the first polishing procedure of step 755 were removed by the second polishing procedure of step 770. If it is determined in step 775 that the polishing marks left on the surface from the first polishing procedure of step 755 were removed by the second polishing procedure of step 770, method 700 proceeds to step 785. Otherwise, if it is determined in step 775 that the polishing marks left on the surface from the first polishing procedure of step 755 were not completely removed by the second polishing procedure of step 770 (i.e., the polishing marks are still visible), method 700 proceeds to step 780. Any appropriate method may be utilized in step 775 to determine if the polishing marks left on the surface from the first polishing procedure of step 755 were completely removed by the second polishing procedure of step 770. If method 700 is performed at least partially by an operator, the operator may visually inspect the surface in order to determine if the polishing marks have been removed. In other embodiments, any computerized visual analysis technique may be utilized in step 775 to determine if the polishing marks have been removed (e.g., using an imaging device such as a camera and any appropriate image analysis software or technique).

At step 780, method 700 repeats one or more steps of step 770 in order to attempt to remove the polishing marks left on the surface from the first polishing procedure of step 755. For example, in some embodiments, step 780 includes first cleaning the surface (e.g., the second polished area described in FIG. 12) using any appropriate materials (e.g., deionized water and a cheese cloth). Next, method 700 may continue to polish the surface in step 780 using the second polishing paste of step 770 for a predetermined amount of additional time (e.g., for thirty minutes). In some embodiments, method 700 may additionally measure the thickness of the polished area (e.g., the second polished area of FIG. 12) to ensure that the thickness of the surface stays within engineering tolerances (e.g., is equal to or greater than a minimum thickness). If the measured thickness of the polished area is found to be at or below a minimum thickness, method 700 may end. After step 780, method 700 returns to step 775 in order to determine whether the polishing marks left on the surface from the first polishing procedure of step 755 were removed.

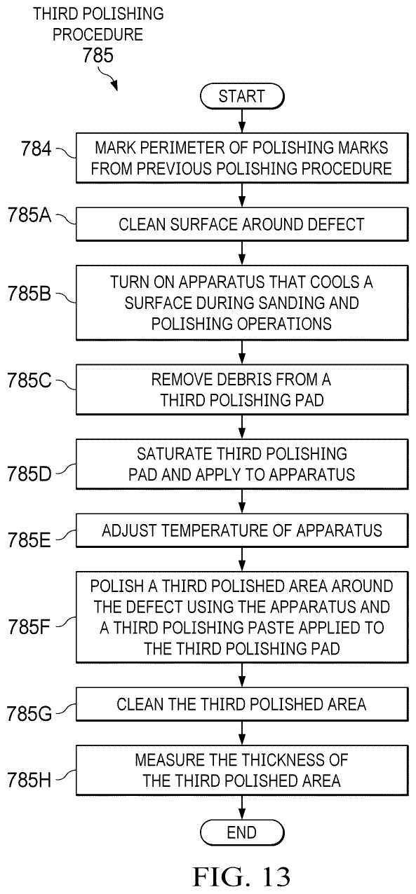

At step 785, method 700 performs a third polishing procedure on the surface using the apparatus that is able to cool the surface during sanding and polishing operations (e.g., apparatus 100). In some embodiments, the third polishing procedure of step 785 is performed using a third polishing pad coupled to the apparatus and a third polishing paste applied to the third polishing pad. In general, the third polishing procedure of step 785 uses a polishing paste with a lower micron value (e.g., one micron) than the second polishing paste of step 770 in order to polish away any polishing marks left on the surface from the second polishing procedure of step 770. A particular embodiment of step 785 is illustrated in FIG. 13 and discussed in more detail below.

At step 790, method 700 determines whether the polishing marks left on the surface from the second polishing procedure of step 770 were removed by the third polishing procedure of step 785. If it is determined in step 790 that the polishing marks left on the surface from the second polishing procedure of step 770 were removed by the third polishing procedure of step 785, method 700 may end. Otherwise, if it is determined in step 790 that the polishing marks left on the surface from the second polishing procedure of step 770 were not completely removed by the third polishing procedure of step 785 (i.e., the polishing marks are still visible), method 700 proceeds to step 795. Any appropriate method may be utilized in step 790 to determine if the polishing marks left on the surface from the second polishing procedure of step 770 were completely removed by the third polishing procedure of step 785. If method 700 is performed at least partially by an operator, the operator may visually inspect the surface in order to determine if the polishing marks have been removed. In other embodiments, any computerized visual analysis technique may be utilized in step 790 to determine if the polishing marks have been removed (e.g., using an imaging device such as a camera and any appropriate image analysis software or technique).

At step 795, method 700 repeats one or more steps of step 785 in order to attempt to remove the polishing marks left on the surface from the second polishing procedure of step 770. For example, in some embodiments, step 795 includes first cleaning the surface (e.g., the third polished area described in FIG. 13) using any appropriate materials (e.g., deionized water and a cheese cloth). Next, method 700 may continue to polish the surface in step 795 using the third polishing paste of step 785 for a predetermined amount of additional time (e.g., for thirty minutes). In some embodiments, method 700 may additionally measure the thickness of the polished area (e.g., the third polished area of FIG. 13) to ensure that the thickness of the surface stays within engineering tolerances (e.g., is equal to or greater than a minimum thickness). If the measured thickness of the polished area is found to be at or below a minimum thickness, method 700 may end. After step 795, method 700 returns to step 790 in order to determine whether the polishing marks left on the surface from the second polishing procedure of step 770 were removed.

In some embodiments, method 700 includes an initial step of determining a depth of the defect within the surface and then comparing the depth to a minimum engineering coating thickness. For example, transparencies for aircraft canopies typically have a minimum engineering coating thickness for the polyurethane resin surface coating that is applied to the transparency. If removing the defect from the surface coating will cause the polyurethane resin surface coating to fall below the minimum engineering coating thickness, method 700 may not be performed. To determine whether removing the defect from the surface coating will cause the polyurethane resin surface coating to fall below the minimum engineering coating thickness, method 700 may first determine an overall thickness of the coating and then subtract the determined thickness of the defect. If removing the defect from the surface coating will not cause the polyurethane resin surface coating to fall below the minimum engineering coating thickness, method 700 may proceed to perform the sanding and polishing procedures described above.

While method 700 has been described herein as including three sanding procedures and three polishing procedures, other embodiments may include more or fewer sanding and polishing procedures. For example, some embodiments may include only two sanding procedures and two polishing procedures. As another example, some embodiments may include four or more sanding procedures and four or more polishing procedures. Furthermore, some embodiments may include unequal numbers of sanding and polishing procedures. For example, some embodiments may include two sanding procedures and three polishing procedures. This disclosure contemplates any appropriate number and combinations of sanding and polishing procedures.

In some embodiments, some or all of method 700 may be performed by an operator. In some embodiments, some or all of method 700 may be automated and performed by a computerized system. For example, apparatus 100 may be coupled to a robotic arm that is programmed to perform some or all of the steps of method 700.

Particular embodiments may repeat one or more steps of the method of FIG. 7, where appropriate. Although this disclosure describes and illustrates particular steps of the method of FIG. 7 as occurring in a particular order, this disclosure contemplates any suitable steps of the method of FIG. 7 occurring in any suitable order. Moreover, although this disclosure describes and illustrates an example method including the particular steps of the method of FIG. 7, this disclosure contemplates any suitable method including any suitable steps, which may include all, some, or none of the steps of the method of FIG. 7, where appropriate. Furthermore, although this disclosure describes and illustrates particular components, devices, or systems carrying out particular steps of the method of FIG. 7, this disclosure contemplates any suitable combination of any suitable components, devices, or systems carrying out any suitable steps of the method of FIG. 7.

FIG. 8 is a chart illustrating a first sanding procedure of step 710 of FIG. 7, according to particular embodiments. At step 710a, the surface around the defect is cleaned. In some embodiments, the surface is cleaned with water (e.g., deionized water) and a cloth (e.g., a cheese cloth). While step 710a is illustrated as occurring as the first step in FIG. 8, it should be understood that step 710a may be performed at any point in the first sanding procedure of FIG. 8 prior to step 710F.

In steps 710B-710E, an apparatus that is operable to cool the surface during sanding and polishing operations (e.g., apparatus 100) is prepared. At step 710B, the apparatus is turned on and enabled for operation. At step 710C, debris is removed from a first sanding pad. In some embodiments, the first sanding pad is a low-grit sanding pad (e.g., 500 grit). In some embodiments, debris is removed from the first sanding pad using tacky tape or the like. At step 710D, the first sanding pad is saturated with water (e.g., deionized water) and the first sanding pad is applied to the apparatus. At step 710E, the temperature of the apparatus is set or otherwise adjusted to maintain a predetermined temperature that is lower than a glass transition temperature of the surface while is also high enough to avoid creating ice particles on the sanding pad while wet sanding (e.g., between 40- and 45-degrees Fahrenheit).

At step 710F, a first sanded area around the defect is wet sanded using the apparatus and the first sanding pad for a predetermined amount of time or until the defect is removed. In some embodiments, the predetermined amount of time is ten minutes. In some embodiments, the first sanded area is a circular area with a first radius that extends outwards from the defect. In some embodiments, the first radius is three inches.

At step 710G, the first sanded area is cleaned. In some embodiments, the first sanded area is cleaned with water (e.g., deionized water) and a cloth (e.g., a cheese cloth).

At step 710H, the first sanded area is measured to ensure that a thickness of the first sanded area is greater than a predetermined thickness. In some embodiments, the predetermined thickness is a minimum engineering coating thickness. In some embodiments, the thickness of the first sanded area is measured using an ultrasonic depth measurement tool. After step 710H, the first sanding procedure of step 710 of FIG. 7 may end.

Particular embodiments may repeat one or more steps of the method of FIG. 8, where appropriate. Although this disclosure describes and illustrates particular steps of the method of FIG. 8 as occurring in a particular order, this disclosure contemplates any suitable steps of the method of FIG. 8 occurring in any suitable order. Moreover, although this disclosure describes and illustrates an example method including the particular steps of the method of FIG. 8, this disclosure contemplates any suitable method including any suitable steps, which may include all, some, or none of the steps of the method of FIG. 8, where appropriate. Furthermore, although this disclosure describes and illustrates particular components, devices, or systems carrying out particular steps of the method of FIG. 8, this disclosure contemplates any suitable combination of any suitable components, devices, or systems carrying out any suitable steps of the method of FIG. 8.

FIG. 9 is a chart illustrating a second sanding procedure of step 725 of FIG. 7, according to particular embodiments. At step 724, the perimeter of the sanding marks that were generated on the surface by the first sanding procedure are marked. In some embodiments, this step includes drawing, using a marker such as a wet erase marker, a line around the perimeter of the sanding marks generated by the first sanding procedure. In some embodiments, the line is drawn on the opposite side of the surface (e.g., on the inside of the canopy transparency) from the surface that is being sanded.

At step 725a, the surface around the defect is cleaned. In some embodiments, the surface is cleaned with water (e.g., deionized water) and a cloth (e.g., a cheese cloth). While step 725a is illustrated as occurring at a particular point in FIG. 9, it should be understood that step 725a may be performed at any point in the second sanding procedure of FIG. 9 prior to step 725F.

In steps 725B-725E, an apparatus that is operable to cool the surface during sanding and polishing operations (e.g., apparatus 100) is prepared. At step 725B, the apparatus is turned on and enabled for operation. At step 725C, debris is removed from a second sanding pad. In some embodiments, the second sanding pad is a sanding pad with a lower grit than the first sanding pad (e.g., 2000 grit). In some embodiments, debris is removed from the second sanding pad using tacky tape or the like. At step 725D, the second sanding pad is saturated with water (e.g., deionized water) and the second sanding pad is applied to the apparatus. At step 725E, the temperature of the apparatus is set or otherwise adjusted to maintain a predetermined temperature that is lower than a glass transition temperature of the surface while is also high enough to avoid creating ice particles on the sanding pad while wet sanding (e.g., between 40- and 45-degrees Fahrenheit).

At step 725F, a second sanded area around the defect is wet sanded using the apparatus and the second sanding pad for a predetermined amount of time. In some embodiments, the predetermined amount of time is thirty minutes. In some embodiments, the second sanded area is a circular area with a second radius that extends outwards from the defect. In some embodiments, the second radius is larger than the first radius of the first sanding procedure (e.g., one inch larger than the first radius of the first sanding procedure).

At step 725G, the second sanded area is cleaned. In some embodiments, the second sanded area is cleaned with water (e.g., deionized water) and a cloth (e.g., a cheese cloth).

At step 725H, the second sanded area is measured to ensure that a thickness of the second sanded area is greater than a predetermined thickness. In some embodiments, the predetermined thickness is a minimum engineering coating thickness. In some embodiments, the thickness of the second sanded area is measured using an ultrasonic depth measurement tool. After step 725H, the second sanding procedure of step 725 of FIG. 7 may end.

Particular embodiments may repeat one or more steps of the method of FIG. 9, where appropriate. Although this disclosure describes and illustrates particular steps of the method of FIG. 9 as occurring in a particular order, this disclosure contemplates any suitable steps of the method of FIG. 9 occurring in any suitable order. Moreover, although this disclosure describes and illustrates an example method including the particular steps of the method of FIG. 9, this disclosure contemplates any suitable method including any suitable steps, which may include all, some, or none of the steps of the method of FIG. 9, where appropriate. Furthermore, although this disclosure describes and illustrates particular components, devices, or systems carrying out particular steps of the method of FIG. 9, this disclosure contemplates any suitable combination of any suitable components, devices, or systems carrying out any suitable steps of the method of FIG. 9.

FIG. 10 is a chart illustrating a third sanding procedure of step 740 of FIG. 7, according to particular embodiments. At step 739, the perimeter of the sanding marks that were generated on the surface by the second sanding procedure are marked. In some embodiments, this step includes drawing, using a marker such as a wet erase marker, a line around the perimeter of the sanding marks generated by the second sanding procedure. In some embodiments, the line is drawn on the opposite side of the surface (e.g., on the inside of the canopy transparency) from the surface that is being sanded.

At step 740a, the surface around the defect is cleaned. In some embodiments, the surface is cleaned with water (e.g., deionized water) and a cloth (e.g., a cheese cloth). While step 740a is illustrated as occurring at a particular point in FIG. 10, it should be understood that step 740a may be performed at any point in the third sanding procedure of FIG. 10 prior to step 740F.

In steps 740B-740E, an apparatus that is operable to cool the surface during sanding and polishing operations (e.g., apparatus 100) is prepared. Step 740B-740E may be performed in any appropriate or desired order at any point in the third sanding procedure of FIG. 10 prior to step 740F. At step 740B, the apparatus is turned on and enabled for operation. At step 740C, debris is removed from a third sanding pad. In some embodiments, the third sanding pad is a sanding pad with a lower grit than the second sanding pad (e.g., 4000 grit). In some embodiments, debris is removed from the third sanding pad using tacky tape or the like. At step 740D, the third sanding pad is applied to the apparatus. At step 740E, the temperature of the apparatus is set or otherwise adjusted to maintain a predetermined temperature that is lower than a glass transition temperature of the surface while is also high enough to avoid creating ice particles on the sanding pad while wet sanding (e.g., between 40- and 45-degrees Fahrenheit).

At step 740F, a third sanded area around the defect is sanded using the apparatus and the third sanding pad for a predetermined amount of time. In some embodiments, the predetermined amount of time is thirty minutes. In some embodiments, the third sanded area is a circular area with a third radius that extends outwards from the defect. In some embodiments, the third radius is larger than the second radius of the second sanding procedure (e.g., one inch larger than the second radius of the second sanding procedure).

At step 740G, the third sanded area is cleaned. In some embodiments, the third sanded area is cleaned with water (e.g., deionized water) and a cloth (e.g., a cheese cloth).

At step 740H, the third sanded area is measured to ensure that a thickness of the third sanded area is greater than a predetermined thickness. In some embodiments, the predetermined thickness is a minimum engineering coating thickness. In some embodiments, the thickness of the third sanded area is measured using an ultrasonic depth measurement tool. After step 740H, the third sanding procedure of step 740 of FIG. 7 may end.

Particular embodiments may repeat one or more steps of the method of FIG. 10, where appropriate. Although this disclosure describes and illustrates particular steps of the method of FIG. 10 as occurring in a particular order, this disclosure contemplates any suitable steps of the method of FIG. 10 occurring in any suitable order. Moreover, although this disclosure describes and illustrates an example method including the particular steps of the method of FIG. 10, this disclosure contemplates any suitable method including any suitable steps, which may include all, some, or none of the steps of the method of FIG. 10, where appropriate. Furthermore, although this disclosure describes and illustrates particular components, devices, or systems carrying out particular steps of the method of FIG. 10, this disclosure contemplates any suitable combination of any suitable components, devices, or systems carrying out any suitable steps of the method of FIG. 10.

FIG. 11 is a chart illustrating a first polishing procedure of step 755 of FIG. 7, according to particular embodiments. At step 754, the perimeter of the sanding marks that were generated on the surface by the third sanding procedure are marked. In some embodiments, this step includes drawing, using a marker such as a wet erase marker, a line around the perimeter of the sanding marks generated by the third sanding procedure. In some embodiments, the line is drawn on the opposite side of the surface (e.g., on the inside of the canopy transparency) from the surface that is being sanded.

At step 755a, the surface around the defect is cleaned. In some embodiments, the surface is cleaned with water (e.g., deionized water) and a cloth (e.g., a cheese cloth). While step 755a is illustrated as occurring at a particular point in FIG. 11, it should be understood that step 755a may be performed at any point in the first polishing procedure of FIG. 11 prior to step 755F.

In steps 755B-755E, an apparatus that is operable to cool the surface during sanding and polishing operations (e.g., apparatus 100) is prepared. At step 755B, the apparatus is turned on and enabled for operation. At step 755C, debris is removed from a first polishing pad. In some embodiments, the first polishing pad is a F1 polishing pad. In some embodiments, debris is removed from the first polishing pad using tacky tape or the like. At step 755D, the first polishing pad is saturated with water (e.g., deionized water) and applied to the apparatus. At step 755E, the temperature of the apparatus is set or otherwise adjusted to maintain a predetermined temperature that is lower than a glass transition temperature of the surface while is also high enough to avoid creating ice particles on the sanding pad while wet sanding (e.g., between 40- and 45-degrees Fahrenheit).

At step 755F, a first polished area around the defect is polished for a predetermined amount of time using the apparatus and a first polishing paste applied to the first polishing pad. In some embodiments, the first polishing paste is a 4-micron, water-based polishing paste. In some embodiments, the predetermined amount of time is one hour. In some embodiments, the first polished area is a circular area with a radius that extends outwards from the defect. In some embodiments, the radius of the first polished area is larger than the radius of the previous (e.g., third) sanding procedure (e.g., one inch larger than the radius of the previous sanding procedure).

At step 755G, the first polished area is cleaned. In some embodiments, the first polished area is cleaned with water (e.g., deionized water) and a cloth (e.g., a cheese cloth).

At step 755H, the first polished area is measured to ensure that a thickness of the first polished area is greater than a predetermined thickness. In some embodiments, the predetermined thickness is a minimum engineering coating thickness. In some embodiments, the thickness of the first polished area is measured using an ultrasonic depth measurement tool. After step 755H, the first polishing procedure of step 755 of FIG. 7 may end.

Particular embodiments may repeat one or more steps of the method of FIG. 11, where appropriate. Although this disclosure describes and illustrates particular steps of the method of FIG. 11 as occurring in a particular order, this disclosure contemplates any suitable steps of the method of FIG. 11 occurring in any suitable order. Moreover, although this disclosure describes and illustrates an example method including the particular steps of the method of FIG. 11, this disclosure contemplates any suitable method including any suitable steps, which may include all, some, or none of the steps of the method of FIG. 11, where appropriate. Furthermore, although this disclosure describes and illustrates particular components, devices, or systems carrying out particular steps of the method of FIG. 11, this disclosure contemplates any suitable combination of any suitable components, devices, or systems carrying out any suitable steps of the method of FIG. 11.

FIG. 12 is a chart illustrating a second polishing procedure of step 770 of FIG. 7, according to particular embodiments. At step 769, the perimeter of the polishing marks that were generated on the surface by the first polishing procedure are marked. In some embodiments, this step includes drawing, using a marker such as a wet erase marker, a line around the perimeter of the polishing marks generated by the first polishing procedure. In some embodiments, the line is drawn on the opposite side of the surface (e.g., on the inside of the canopy transparency) from the surface that is being sanded.

At step 770a, the surface around the defect is cleaned. In some embodiments, the surface is cleaned with water (e.g., deionized water) and a cloth (e.g., a cheese cloth). While step 770a is illustrated as occurring at a particular point in FIG. 12, it should be understood that step 770a may be performed at any point in the second polishing procedure of FIG. 12 prior to step 770F.

In steps 770B-770E, an apparatus that is operable to cool the surface during sanding and polishing operations (e.g., apparatus 100) is prepared. At step 770B, the apparatus is turned on and enabled for operation. At step 770C, debris is removed from a second polishing pad. In some embodiments, the second polishing pad is a F1 polishing pad. In some embodiments, debris is removed from the second polishing pad using tacky tape or the like. At step 770D, the second polishing pad is saturated with water (e.g., deionized water) and applied to the apparatus. At step 770E, the temperature of the apparatus is set or otherwise adjusted to maintain a predetermined temperature that is lower than a glass transition temperature of the surface while is also high enough to avoid creating ice particles on the sanding pad while wet sanding (e.g., between 40- and 45-degrees Fahrenheit).

At step 770F, a second polished area around the defect is polished for a predetermined amount of time using the apparatus and a second polishing paste applied to the second polishing pad. In some embodiments, the second polishing paste is a 2-micron, water-based polishing paste. In some embodiments, the predetermined amount of time is one hour. In some embodiments, the second polished area is a circular area with a radius that extends outwards from the defect. In some embodiments, the radius of the second polished area is larger than the radius of the area of the previous procedure (e.g., one inch larger than the radius of the first polishing procedure).

At step 770G, the second polished area is cleaned. In some embodiments, the second polished area is cleaned with water (e.g., deionized water) and a cloth (e.g., a cheese cloth).

At step 770H, the second polished area is measured to ensure that a thickness of the second polished area is greater than a predetermined thickness. In some embodiments, the predetermined thickness is a minimum engineering coating thickness. In some embodiments, the thickness of the second polished area is measured using an ultrasonic depth measurement tool. After step 770H, the second polishing procedure of step 770 of FIG. 7 may end.

Particular embodiments may repeat one or more steps of the method of FIG. 12, where appropriate. Although this disclosure describes and illustrates particular steps of the method of FIG. 12 as occurring in a particular order, this disclosure contemplates any suitable steps of the method of FIG. 12 occurring in any suitable order. Moreover, although this disclosure describes and illustrates an example method including the particular steps of the method of FIG. 12, this disclosure contemplates any suitable method including any suitable steps, which may include all, some, or none of the steps of the method of FIG. 12, where appropriate. Furthermore, although this disclosure describes and illustrates particular components, devices, or systems carrying out particular steps of the method of FIG. 12, this disclosure contemplates any suitable combination of any suitable components, devices, or systems carrying out any suitable steps of the method of FIG. 12.

FIG. 13 is a chart illustrating a third polishing procedure of step 785 of FIG. 7, according to particular embodiments. At step 784, the perimeter of the polishing marks that were generated on the surface by the second polishing procedure are marked. In some embodiments, this step includes drawing, using a marker such as a wet erase marker, a line around the perimeter of the polishing marks generated by the second polishing procedure. In some embodiments, the line is drawn on the opposite side of the surface (e.g., on the inside of the canopy transparency) from the surface that is being sanded.

At step 785a, the surface around the defect is cleaned. In some embodiments, the surface is cleaned with water (e.g., deionized water) and a cloth (e.g., a cheese cloth). While step 785a is illustrated as occurring at a particular point in FIG. 13, it should be understood that step 785a may be performed at any point in the third polishing procedure of FIG. 13 prior to step 785F.

In steps 785B-785E, an apparatus that is operable to cool the surface during sanding and polishing operations (e.g., apparatus 100) is prepared. At step 785B, the apparatus is turned on and enabled for operation. At step 785C, debris is removed from a third polishing pad. In some embodiments, the third polishing pad is a F1 polishing pad. In some embodiments, debris is removed from the third polishing pad using tacky tape or the like. At step 785D, the third polishing pad is saturated with water (e.g., deionized water) and applied to the apparatus. At step 785E, the temperature of the apparatus is set or otherwise adjusted to maintain a predetermined temperature that is lower than a glass transition temperature of the surface while is also high enough to avoid creating ice particles on the sanding pad while wet sanding (e.g., between 40- and 45-degrees Fahrenheit).

At step 785F, a third polished area around the defect is polished for a predetermined amount of time using the apparatus and a third polishing paste applied to the third polishing pad. In some embodiments, the third polishing paste is a 1-micron, water-based polishing paste. In some embodiments, the predetermined amount of time is one hour. In some embodiments, the third polished area is a circular area with a radius that extends outwards from the defect. In some embodiments, the radius of the third polished area is larger than the radius of the area of the previous procedure (e.g., one inch larger than the radius of the second polishing procedure).

At step 785G, the third polished area is cleaned. In some embodiments, the third polished area is cleaned with water (e.g., deionized water) and a cloth (e.g., a cheese cloth).

At step 785H, the third polished area is measured to ensure that a thickness of the third polished area is greater than a predetermined thickness. In some embodiments, the predetermined thickness is a minimum engineering coating thickness. In some embodiments, the thickness of the third polished area is measured using an ultrasonic depth measurement tool. After step 785H, the third polishing procedure of step 785 of FIG. 7 may end.

Particular embodiments may repeat one or more steps of the method of FIG. 13, where appropriate. Although this disclosure describes and illustrates particular steps of the method of FIG. 13 as occurring in a particular order, this disclosure contemplates any suitable steps of the method of FIG. 13 occurring in any suitable order. Moreover, although this disclosure describes and illustrates an example method including the particular steps of the method of FIG. 13, this disclosure contemplates any suitable method including any suitable steps, which may include all, some, or none of the steps of the method of FIG. 13, where appropriate. Furthermore, although this disclosure describes and illustrates particular components, devices, or systems carrying out particular steps of the method of FIG. 13, this disclosure contemplates any suitable combination of any suitable components, devices, or systems carrying out any suitable steps of the method of FIG. 13.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

Moreover, the description in this patent document should not be read as implying that any particular element, step, or function can be an essential or critical element that must be included in the claim scope. Also, none of the claims can be intended to invoke 35 U.S.C. § 112 (f) with respect to any of the appended claims or claim elements unless the exact words “means for” or “step for” are explicitly used in the particular claim, followed by a participle phrase identifying a function. Use of terms such as (but not limited to) “member,” “module,” “device,” “unit,” “component,” “element,” “mechanism,” “apparatus,” “machine,” “system,” “processor,” “processing device,” or “controller” within a claim can be understood and intended to refer to structures known to those skilled in the relevant art, as further modified or enhanced by the features of the claims themselves, and can be not intended to invoke 35 U.S.C. § 112 (f). Even under the broadest reasonable interpretation, in light of this paragraph of this specification, the claims are not intended to invoke 35 U.S.C. § 112 (f) absent the specific language described above.

While the include figures illustrate particular embodiments having particular components, this disclosure contemplates other embodiments having some or all of the described components, as well as additional components not described. Components of the present disclosure may be any suitable shape and may be in any suitable configuration.

As used in this document, “each” refers to each member of a set or each member of a subset of a set. Furthermore, as used in the document “or” is not necessarily exclusive and, unless expressly indicated otherwise, can be inclusive in certain embodiments and can be understood to mean “and/or.” Similarly, as used in this document “and” is not necessarily inclusive and, unless expressly indicated otherwise, can be inclusive in certain embodiments and can be understood to mean “and/or.”

The disclosure may be embodied in other specific forms without departing from the spirit or essential characteristics thereof. For example, each of the new structures described herein, may be modified to suit particular local variations or requirements while retaining their basic configurations or structural relationships with each other or while performing the same or similar functions described herein. The present embodiments are therefore to be considered in all respects as illustrative and not restrictive. Accordingly, the scope of the disclosures can be established by the appended claims rather than by the foregoing description. All changes which come within the meaning and range of equivalency of the claims are therefore intended to be embraced therein. Further, the individual elements of the claims are not well-understood, routine, or conventional. Instead, the claims are directed to the unconventional inventive concept described in the specification.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, functions, operations, or steps, any of these embodiments may include any combination or permutation of any of the components, elements, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative.

1. A method for removing a defect from an aircraft transparency, the method comprising:
preparing an apparatus that is operable to cool a surface during sanding and polishing operations;
performing a first sanding procedure on the aircraft transparency using the apparatus and a first sanding pad coupled to the apparatus;
if the defect is removed by the first sanding procedure, performing a second sanding procedure on the aircraft transparency using the apparatus, wherein the second sanding procedure utilizes a second sanding pad coupled to the apparatus that has a higher grit value than the first sanding pad;
performing, using the apparatus, a first polishing procedure on the aircraft transparency in order to remove sanding marks on the aircraft transparency from a previous sanding procedure, wherein the first polishing procedure utilizes a first polishing pad coupled to the apparatus and a first polishing paste applied to the first polishing pad; and
if the first polishing procedure removes all sanding marks on the aircraft transparency from the previous sanding procedure, performing a second polishing procedure on the aircraft transparency using the apparatus, wherein the second polishing procedure utilizes a second polishing pad coupled to the apparatus and a second polishing paste applied to the second polishing pad, the second polishing paste having a lower micron value than the first polishing paste.

2. The method of claim 1, wherein the apparatus comprises:
a sanding head;
a motor configured to actuate the sanding head; and
at least one cooling fluid device fluidly connected to the sanding head and configured to provide compressed air through the sanding head in order to cool the surface during sanding and polishing operations.

3. The method of claim 1, further comprising:
if the second polishing procedure removes all polishing marks on the aircraft transparency from the first polishing procedure, performing a third polishing procedure on the aircraft transparency using the apparatus, wherein the third polishing procedure utilizes a third polishing pad coupled to the apparatus and a third polishing paste applied to the third polishing pad, the third polishing paste having a lower micron value than the second polishing paste.

4. The method of claim 1, further comprising:
if the second sanding procedure removes all sanding marks on the aircraft transparency from the first sanding procedure, performing a third sanding procedure on the aircraft transparency using the apparatus, wherein the third sanding procedure utilizes a third sanding pad coupled to the apparatus that has a higher grit value than the second sanding pad.

5. The method of claim 1, wherein preparing the apparatus comprises:
adjusting the apparatus to maintain a predetermined temperature;
removing debris from the first sanding pad; and
saturating the first sanding pad with water.

6. The method of claim 5, wherein:
the predetermined temperature is less than a glass transition temperature of the aircraft transparency;
removing debris from the first sanding pad comprises utilizing tacky tape; and
the water comprises deionized water.

7. The method of claim 1, wherein:
the first sanding procedure includes sanding a first sanded area for a first predetermined amount of time, the first sanded area comprising a first radius extending outwards from the defect;
the second sanding procedure includes sanding a second sanded area for a second predetermined amount of time that is longer than the first amount of time, the second sanded area comprising a second radius extending outwards from the defect, the second radius being larger than the first radius.

8. The method of claim 7, wherein:
the first sanding procedure includes measuring, after the first predetermined amount of time, the first sanded area to ensure that a thickness of the first sanded area is greater than a predetermined thickness; and
the second sanding procedure includes measuring, after the second predetermined amount of time, the second sanded area to ensure that a thickness of the second sanded area is greater than the predetermined thickness.

9. The method of claim 1, wherein:
the first polishing procedure includes polishing a first polished area for a third predetermined amount of time, the first polished area comprising a third radius extending outwards from the defect;
the second polishing procedure includes polishing a second polished area for a fourth predetermined amount of time, the second polished area comprising a fourth radius extending outwards from the defect, the fourth radius being larger than the third radius.

10. The method of claim 9, wherein:
the first polishing procedure includes measuring, after the third predetermined amount of time, the first polished area to ensure that a thickness of the first polished area is greater than a predetermined thickness; and
the second polishing procedure includes measuring, after the fourth predetermined amount of time, the second polished area to ensure that a thickness of the second polished area is greater than the predetermined thickness.

11. A method for removing a defect from a surface, the method comprising:
performing a first sanding procedure on the surface using an apparatus and a first sanding pad coupled to the apparatus, the apparatus operable to cool the surface during sanding and polishing operations;
if the defect is removed by the first sanding procedure, performing a second sanding procedure on the surface using the apparatus, wherein the second sanding procedure utilizes a second sanding pad coupled to the apparatus that has a higher grit value than the first sanding pad;
performing, using the apparatus, a first polishing procedure on the surface in order to remove sanding marks on the surface from a previous sanding procedure, wherein the first polishing procedure utilizes a first polishing pad coupled to the apparatus and a first polishing paste applied to the first polishing pad; and
if the first polishing procedure removes sanding marks on the surface from the previous sanding procedure, performing a second polishing procedure on the surface using the apparatus, wherein the second polishing procedure utilizes a second polishing pad coupled to the apparatus and a second polishing paste applied to the second polishing pad, the second polishing paste having a lower micron value than the first polishing paste.

12. The method of claim 11, wherein the apparatus comprises:
a sanding head;
a motor configured to actuate the sanding head; and
at least one cooling fluid device fluidly connected to the sanding head and configured to provide compressed air through the sanding head in order to cool the surface during sanding and polishing operations.

13. The method of claim 11, further comprising:
if the second polishing procedure removes all polishing marks on the surface from the first polishing procedure, performing a third polishing procedure on the surface using the apparatus, wherein the third polishing procedure utilizes a third polishing pad coupled to the apparatus and a third polishing paste applied to the third polishing pad, the third polishing paste having a lower micron value than the second polishing paste.

14. The method of claim 11, further comprising:
if the second sanding procedure removes all sanding marks on the surface from the first sanding procedure, performing a third sanding procedure on the surface using the apparatus, wherein the third sanding procedure utilizes a third sanding pad coupled to the apparatus that has a higher grit value than the second sanding pad.

15. The method of claim 11, further comprising preparing the apparatus by:
adjusting the apparatus to maintain a predetermined temperature;
removing debris from the first sanding pad; and
saturating the first sanding pad with water.

16. The method of claim 15, wherein:
the predetermined temperature is less than a glass transition temperature of the surface;
removing debris from the first sanding pad comprises utilizing tacky tape; and
the water comprises deionized water.

17. The method of claim 11, wherein:
the first sanding procedure includes sanding a first sanded area for a first predetermined amount of time, the first sanded area comprising a first radius extending outwards from the defect;
the second sanding procedure includes sanding a second sanded area for a second predetermined amount of time that is longer than the first amount of time, the second sanded area comprising a second radius extending outwards from the defect, the second radius being larger than the first radius.

18. The method of claim 17, wherein:
the first sanding procedure includes measuring, after the first predetermined amount of time, the first sanded area to ensure that a thickness of the first sanded area is greater than a predetermined thickness; and
the second sanding procedure includes measuring, after the second predetermined amount of time, the second sanded area to ensure that a thickness of the second sanded area is greater than the predetermined thickness.

19. The method of claim 11, wherein:
the first polishing procedure includes polishing a first polished area for a third predetermined amount of time, the first polished area comprising a third radius extending outwards from the defect;
the second polishing procedure includes polishing a second polished area for a fourth predetermined amount of time, the second polished area comprising a fourth radius extending outwards from the defect, the fourth radius being larger than the third radius.

20. The method of claim 19, wherein:
the first polishing procedure includes measuring, after the third predetermined amount of time, the first polished area to ensure that a thickness of the first polished area is greater than a predetermined thickness; and
the second polishing procedure includes measuring, after the fourth predetermined amount of time, the second polished area to ensure that a thickness of the second polished area is greater than the predetermined thickness.
